(19) United States
(12) Patent Application Publication
(10) Pub. No.: US 2017/0000141 A1
(43) Pub. Date: Jan. 5, 2017

(54) Method of Manufacturing Cut Whole Kimchi

(71) Applicant: CJ CHEILJEDANG CORPORATION, Seoul (KR)

(72) Inventors: Kyu Chong Cho, Seoul (KR); Min Soo Kwon, Gyeonggi-do (KR); Woo Young Choi, Seoul (KR); Won Dae Chung, Seoul (KR)

(21) Appl. No.: 15/125,933

(22) PCT Filed: Apr. 3, 2015
(86) PCT No.: PCT/KR2015/003348

§ 371 Date: Sep. 13, 2016

(30) Foreign Application Priority Data
Apr. 3, 2014 (KR) 10-2014-0040033

(51) Int. Cl. A23B 7/10

(52) U.S. Cl. CPC A23B 7/105; A23V 2002/00

(57) ABSTRACT

Disclosed is a method of manufacturing cut whole kimchi. More particularly, a method of manufacturing cut whole kimchi to enhance productivity while maintaining a shape and characteristics of the whole kimchi is disclosed.

The method of manufacturing cut whole kimchi of the present invention includes salting Chinese cabbage after removing a root portion of the Chinese cabbage such that each of Chinese cabbage leaves is separated; washing the salted Chinese cabbage leaves with water to remove salt and foreign materials; mixing the washed Chinese cabbage leaves and seasoning in a mixer to manufacture kimchi; arranging the mixed kimchi in a long axial direction using a sorter to laminate; cutting the arranged kimchi into a constant size using a cutter; and packing the cut kimchi.

### TECHNICAL FIELD

The present invention relates to a method of manufacturing cut whole kimchi. More particularly, the present invention relates to a method of manufacturing cut whole kimchi to enhance productivity while maintaining a shape and characteristics of the whole kimchi.

### BACKGROUND ART

Chinese cabbage-kimchi is generally classified into whole kimchi and instant kimchi according to a shape of kimchi.

Whole kimchi is manufactured into a whole kimchi shape by removing salt and washing to adjust a salty taste after cutting Chinese cabbage into two or four pieces and salting, and then by inserting prepared seasoning between Chinese cabbage leaves, according to a traditional manner that has been in use since ancient time.

Whole kimchi is delicate and classy, and excellent long term stability in storage. However, whole kimchi must be inconveniently cut using rubber gloves and a cutting board every meal. When rubber gloves or vinyl gloves are not used, hands may be stained with kimchi juice, and a used cutting board and knife must be washed.

Instant kimchi is prepared by salting, desalting, washing, and mixing seasoning after previously removing a root portion of Chinese cabbage and then cutting the Chinese cabbage. The method of manufacturing the instant kimchi is identical to that of Geotjeori kimchi, except for the salting and desalting.

Although instant kimchi does not need to be cut every meal, instant kimchi is not delicate. Therefore, households or general food-service establishments are unwilling to use the instant kimchi.

Among the two kimchi types described above, consumers generally prefer to whole kimchi. Meanwhile, the number of households self-manufacturing and kimchi consumption continues to decrease. However, consumption of commercial kimchi manufactured by professional manufacturers is increasing.

Accordingly, professional manufacturers are performing research into a variety of methods and facilities to industrially and mass-produce kimchi. In addition, the professional manufacturers are reducing production costs and improving production efficiency by automating many processes to manufacture kimchi.

However, seasoning insertion of whole kimchi, to which consumers prefer, is being performed by spreading seasoning on each leaf while flipping leaves one by one, in the same manner as in household preparation.

Although consumers require delicate whole kimchi, a final consumer price increases due to high personnel expenses and low productivity.

To resolve this problem, as conventional methods of manufacturing whole kimchi, Korean Patent No. 10-0260788 suggests a method of inserting kimchi seasoning by spraying prepared seasoning at high pressure while rotating whole Chinese cabbage and Korean Patent No. 10-1283258 suggests a method of spreading seasoning while flipping leaves of whole Chinese cabbage one by one, using a board to flip and a brush.

However, the conventional methods of manufacturing whole kimchi have limitation in that liquid seasoning and solid seasoning are not evenly distributed and seasoning does not reach to a portion surrounding a root portion. Therefore, satisfaction for the conventional methods is low.

### DISCLOSURE

### Technical Problem

Therefore, the present invention has been made in view of the above problems, and it is one object of the present invention to provide a method of manufacturing cut whole kimchi by salting each leaf of Chinese cabbage, separated after removing a root portion of the Chinese cabbage such that salt concentrations of all Chinese cabbage leaves are uniform, seasoning is uniform, and a shape and characteristics of whole kimchi are maintained.

### Technical Solution

In accordance with one aspect of the present invention, provided is a method of manufacturing cut whole kimchi, the method including salting separated leaves after removing a root portion of Chinese cabbage such that each Chinese cabbage leaf is separated; washing the salted Chinese cabbage leaves to remove salt and foreign materials from the salted Chinese cabbage leaves; mixing the washed Chinese cabbage leaves and seasoning in a mixer to manufacture kimchi; arranging the mixed kimchi in a long axial direction using a sorter so as to laminate the Chinese cabbage leaves; cutting the arranged kimchi into a constant size using a cutter; and packing the cut kimchi. In addition, before the cutting, the kimchi, which is arranged using the sorter, may be additionally pressed in a mold to mold.

### Advantageous Effects

As apparent from the foregoing, the present invention advantageously provides a method of manufacturing cut whole kimchi, having effects as follows.

First, by separately salting each Chinese cabbage leaf in a salting step, variation in salinity per kimchi parts may be reduced.

Second, in a mixing step, one worker may apply seasoning to 30 to 40 kg of whole kimchi per hour. However, by mixing separately salted Chinese cabbage leaves and seasoning in a mixer, 800 to 1,000 kg of kimchi may be manufactured per hour and, thus, a 20 to 25 fold increase in output.

Third, through an automation process in which an arrangement step, a molding step, and a cutting step are continuously performed, whole type kimchi, which is delicately cut, may be manufactured at a rate of approximately 250 to 300 kg per hour.

As described above, by the method according to the present invention, producers may inexpensively provide kimchi, which has delicately cut appearance and a uniformly salted state, to consumers, with productivity approximately 8 times higher than a conventional method, based on a final product.

### DESCRIPTION OF DRAWINGS

FIG. 1 illustrates a flowchart of a process of a method of manufacturing cut whole kimchi according to an embodiment of the present invention;

FIG. 2 illustrates a mixer in a method of manufacturing cut whole kimchi according to an embodiment of the present invention;

FIG. 3 illustrates a plane view (a) and a side view (b) representing a composition of an arranger in a method of manufacturing cut whole kimchi according to an embodiment of the present invention;

FIG. 4 illustrates a side view of a mold and a cutter in a method of manufacturing cut whole kimchi according to an embodiment of the present invention;

FIG. 5 illustrates a sectional view representing a composition of a mold in a method of manufacturing cut whole kimchi according to an embodiment of the present invention;

FIG. 6 illustrates kimchi manufactured according to a method of manufacturing cut whole kimchi according to an embodiment of the present invention; and

FIG. 7 illustrates a sectional view representing a structure of a cutter in a method of manufacturing cut whole kimchi according to an embodiment of the present invention.

### BEST MODE

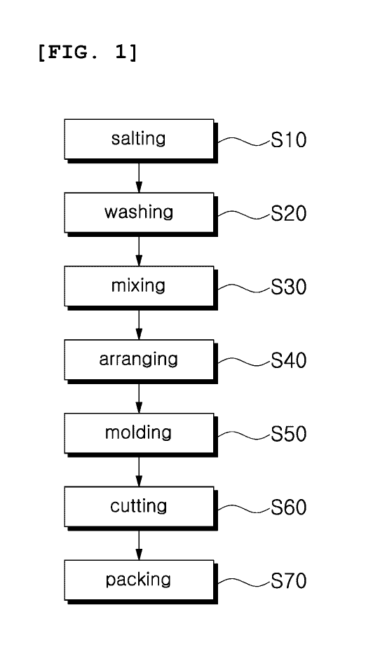

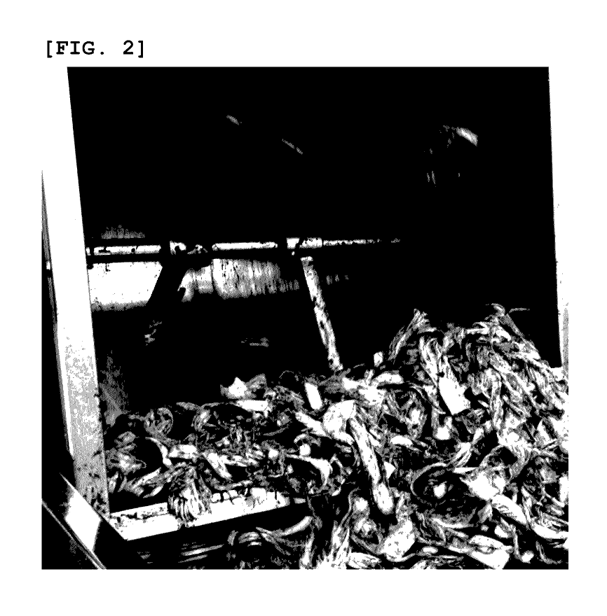

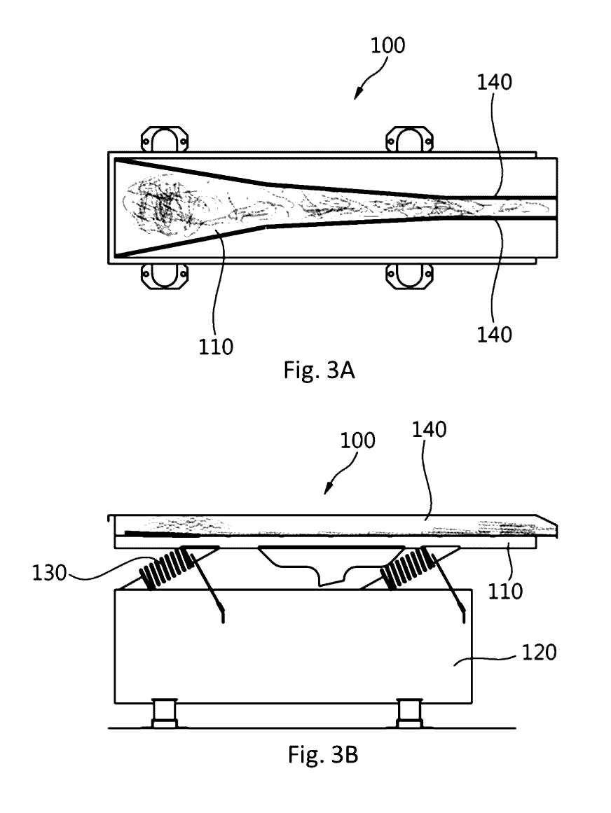

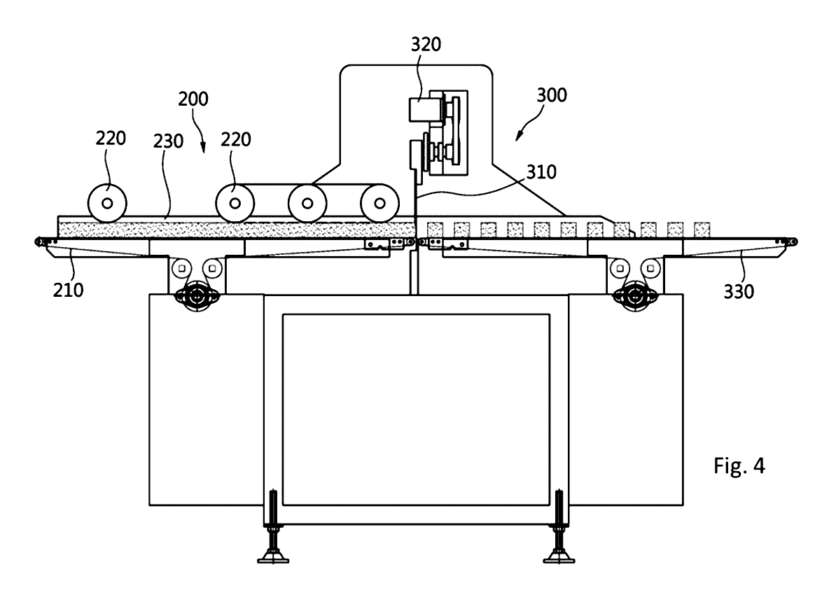

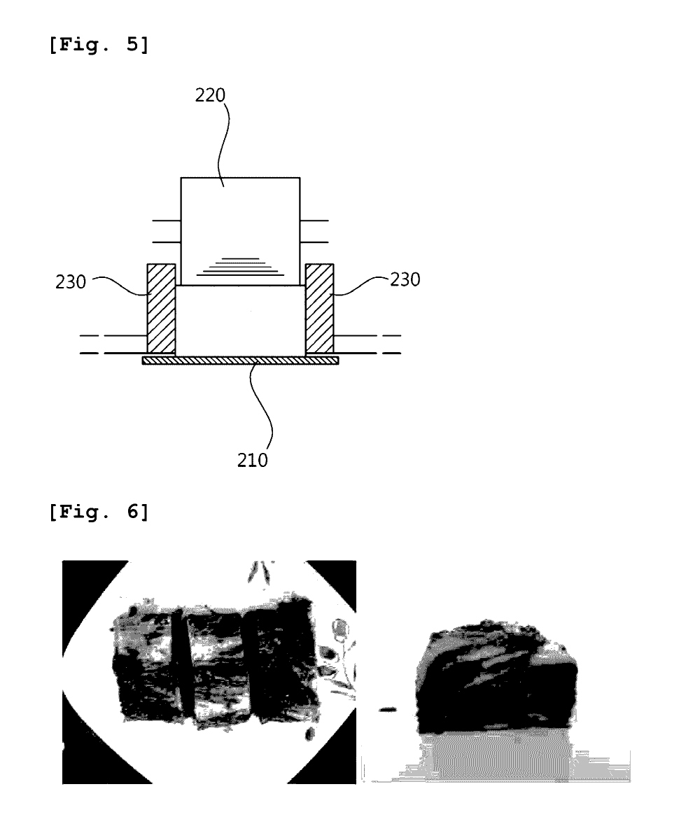

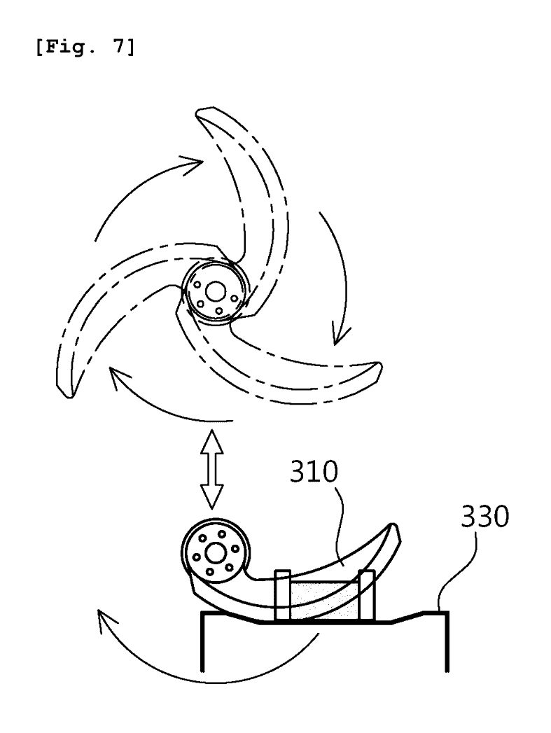

FIG. 1 illustrates a flowchart of a process of a method of manufacturing cut whole kimchi according to an embodiment of the present invention, FIG. 2 illustrates a mixer in a method of manufacturing cut whole kimchi according to an embodiment of the present invention, FIG. 3 illustrates a plan view and a side view representing a composition of an arranger in a method of manufacturing cut whole kimchi according to an embodiment of the present invention, FIG. 4 illustrates a side view of a mold and a cutter in a method of manufacturing cut whole kimchi according to an embodiment of the present invention, FIG. 5 illustrates a sectional view representing a composition of a mold in a method of manufacturing cut whole kimchi according to an embodiment of the present invention, FIG. 6 illustrates kimchi manufactured according to a method of manufacturing cut whole kimchi according to an embodiment of the present invention, and FIG. 7 illustrates a sectional view representing a structure of a cutter in a method of manufacturing cut whole kimchi according to an embodiment of the present invention.

As illustrated in FIG. 1, the method of manufacturing cut whole kimchi according to an embodiment of the present invention includes salting separated leaves after removing a root portion of Chinese cabbage such that each Chinese cabbage leaf is separated (S10), washing the salted Chinese cabbage leaves to remove salt and foreign materials from the salted Chinese cabbage leaves (S20), mixing the washed Chinese cabbage leaves and seasoning in a mixer to manufacture kimchi (S30), arranging the kimchi, which is present in the mixer, in a long axial direction using a sorter 100 so as to laminate (S40), pressing the arranged kimchi using a mold 100 so as to mold the kimchi (S50), cutting the molded kimchi into a constant size using the cutter 300 (S60), and packing the cut kimchi (S70).

Hereinafter, embodiments of the present invention will be explained in detail with reference to the attached drawings.

The salting S10 is a step of salting the Chinese cabbage leaves after removing the root portion of the Chinese cabbage. More particularly, the salting S10 is a step of soaking the Chinese cabbage leaves in brine, namely, salting water for a certain time after removing the root portion of the Chinese cabbage and separating each Chinese cabbage leaf.

As described above, by removing the root portion of the Chinese cabbage and salting the Chinese cabbage leaves in brine, namely, salting water, salinity variation in Chinese cabbage leaves may be reduced and, thus, taste variation may be reduced.

That is, when whole kimchi is salted using general brine, thick midribs, which are generally called stem, around the inside of a root portion are salted to lower salinity than laminas corresponding to leaf portions, under an identical condition.

In addition, outer leaves, middle leaves, and inner leaves have different salinities.

To resolve this problem, dried salt is used but, although dried salt is used, salt concentration difference during salting is sometimes 1% or more.

As described above, salt concentration difference may be caused by characteristics of plant tissues. In addition, when whole kimchi is salted, circulation of brine and water dehydrated from Chinese cabbage does not fluently reach to deep portions inside a root portion and, thus, salt concentrations vary.

In the present invention, since Chinese cabbage leaves are salted with brine, namely, salting water, after removing a root portion and separating each of the Chinese cabbage leaves, brine evenly circulates the separated Chinese cabbage leaves, thus, salt concentration difference which is different per kimchi portions may be reduced. As a result, variation of kimchi taste may be reduced.

The washing S20 is a step of washing with water to remove salt and foreign materials from the salted Chinese cabbage leaves.

More particularly, the washing S20 is a step of desalting to adjust taste after salting and removing foreign materials from the Chinese cabbage leaves, by washing the Chinese cabbage leaves, which are soaked in brine for a certain time, with water.

The mixing S30 is a step of mixing the washed Chinese cabbage leaves and seasoning in a mixer to manufacture kimchi.

More particularly, the mixing S30 is a step of mixing the washed Chinese cabbage leaves and seasoning in a mixer, as illustrated described in FIG. 2, to manufacture kimchi satisfactorily covered with seasoning. The present invention aims to manufacture kimchi on a large scale. Therefore, large amounts of the washed Chinese cabbage leaves and seasoning were added to and mixed in a mixer.

The arranging (S40) is a step of arranging the kimchi, which is manufactured using the mixer, in a long axial direction using a sorter 100 so as to upwardly and downwardly laminate the kimchi.

In this regard, “long axial direction” means a stem direction of Chinese cabbage leaves, which is a longest portion of kimchi.

More particularly, the arranging (S40) is a step of moving while arranging the kimchi in a long axial direction using the sorter 100 after adding the kimchi, which is mixed with seasoning using the mixer, to the sorter 100, so as to laminate the kimchi.

Here, as illustrated in FIG. 3, the sorter 100 includes a base 110 on which the kimchi is deposited, a vibrator 120 moving the kimchi in one direction by vibrating the base 110; a vibration transmission member 130, one terminal of which is installed to the base 110 and another terminal of which is installed to the vibrator 120, to transmit the vibration from the vibrator 120 to the base 110; and guides 140, which are installed on the left and right sides of an upper portion of the base 110 and a distance of which is narrowed when the kimchi on the base 110 moves in one direction through vibration of the vibrator 120.

An operating state of the sorter 100 will be described in detail. When the vibrator 120 is operated after putting the disordered kimchi, which is manufactured using the mixer, on the base 110, which has a wide distance, of the guides 140, the vibration of the vibrator 120 is transmitted to the base 110 via the vibration transmission member 130 and, thus, the base 110 vibrates.

As described above, when the base 110 vibrates, the kimchi, which is disorderly arranged on the base 110, moves in one direction through the vibration. Here, the kimchi moves to a narrow distance portion of the guides 140 and, thus, the kimchi is arranged in a long axial direction by the guides 140.

In addition, when the kimchi arranged as described above reaches a terminal portion, which has a narrow distance, of the guides 140, the kimchi arranged in a long axial direction is laminated.

On an upper surface of the base 110 moving the kimchi through vibration as described above, irregularities or embossments may be formed or a mash net may be attached thereto, to reduce portions contacting the kimchi and to facilitate movement of the kimchi through vibration.

In addition, the vibration transmission member 130 transmits vibration via a variety of elements but vibration is preferably transmitted via a spring for superior vibration transmission, as illustrated in FIG. 3 (b).

The molding (S50) is a step of pressing the kimchi, which is arranged by the sorter 100, in a mold 200 so as to mold the kimchi.

More particularly, the molding (S50) is a step of pressing the kimchi laminated by the arranging (S40) to remove air inside the kimchi and uniformly forming a shape thereof at the same time.

In this regard, as illustrated in FIGS. 4 and 5, the mold 200 includes a first conveyor 210 moving the kimchi while supporting an upper portion of the kimchi; a pressure roller 220 downwardly pressing the kimchi which is disposed on the upper portion of the first conveyor 210 and is moved by the first conveyor 210, and a support board 230 supporting both side portions of the kimchi pressed by the pressure roller 220.

An operation mechanism of the mold 200 will be described in detail. As illustrated in FIG. 4, when the kimchi laminated by the arranging (S40) is moved by the first conveyor 210, the pressure roller 220 disposed on an upper portion of the first conveyor 210 downwardly adds pressure to the kimchi to remove air inside the kimchi.

In this regard, as illustrated in FIG. 5, the support board 230 forms the kimchi pressed by the pressure roller 220 in a almost constant rectangular shape while supporting left and right sides of the kimchi pressed by the pressure roller 220 such that the kimchi is not scattered.

The molding (S50) may be omitted since the kimchi has almost a whole kimchi shape through the arranging (S40). However, it is preferable to press the arranged kimchi, in which the molding (S50) is further performed, since characteristics of general whole kimchi may be excellently expressed.

Since the kimchi laminated through the arranging (S40) has air layers between the leaves, appearance of the kimchi is poorer than that of whole kimchi adhered without pores.

In addition, when the cutting (S60) described below is performed, the kimchi uniformly laminated may be scattered.

In addition, with respect to stable store, fermentation rapidly proceeds when air layers exist between the kimchi leaves and, thus, kimchi is rapidly fermented. Accordingly, an optimal eating period (time point that sourness due to fermentation of lactic acid bacterium is optimal. Preference reduces since sourness becomes strong after the time point and quality is significantly deteriorated due to yeast proliferation) is reduced and, thus, an expiration date is shortened.

To resolve the problems, in households manufacturing kimchi, manufactured kimchi is compactly put into a container.

According to the present invention, the kimchi has appearance and quality similar to whole kimchi by removing air inside the kimchi through the molding (S50) and maintaining a shape thereof at the same time. In addition, an expiration date of the kimchi may be more extended.

Furthermore, when the kimchi is cut into a proper size to eat in the cutting (S60), which is a next process, scattering of the kimchi may be minimized and, thus, a whole kimchi shape cut into a proper size to eat may be expressed.

The cutting (S60) is a step of cutting the molded kimchi into a constant size using the cutter 300.

More particularly, as illustrated in FIG. 4, the cutting (S60) is a step of cutting the kimchi, which is molded, into a proper size to eat while maintaining whole kimchi appearance, using the cutter 300.

In this regard, as illustrated in FIGS. 4 and 7, the cutter 300 includes a cutting blade 310 to cut the kimchi; an operation part 320 to drive the cutting blade 310; and a second conveyor 330 to move the kimchi cut by the cutting blade 310.

An operation mechanism of the cutter 300 will be described in detail. As illustrated in FIG. 4, the kimchi molded by the molding (S50) moves from the first conveyor 210 to the second conveyor 330.

Accordingly, as illustrated in FIG. 7, the cutting blade 310, which has a crescent shape and one terminal of which is installed on the operation part 320, moves upwardly and downwardly while being rotated by the operation part 320, to cut the kimchi on the first conveyor 210. The cut kimchi is moved to a next process by the second conveyor 330.

In the embodiment, the cutting blade 310, which has a crescent shape and one terminal of which is installed on the operation part 320, upwardly and downwardly moves while rotating, to cut the kimchi. However, as another embodiment, the cutting blade 310 may be formed into a variety of shapes and may be formed into an ax shape or circular shape. However, the present invention is not limited thereto.

When the cutting blade 310 is formed into an ax shape, the operation part 320 may upwardly and downwardly move the cutting blade 310, to cut the kimchi. On the other hand, when the cutting blade 310 is formed into a circular shape, the operation part 320 upwardly and downwardly moves the cutting blade 310 while rotating the cutting blade 310, to cut kimchi.

However, when the cutting blade 310 is formed into an ax shape or a circular shape, the cutting blade 310 contacts the arranged kimchi when the cutting blade 310 is elevated after the cutting blade 310 descended cuts the kimchi and, thus, the arranged kimchi may be scattered.

Therefore, as described in the present invention, the cutting blade 310 is preferably formed into a crescent shape. One terminal of the formed cutting blade 310 is installed on the operation part 320 and, thus the cutting blade 310 upwardly and downwardly moves by rotation. Accordingly, when the cutting blade 310 is elevated, the cutting blade 310 does not contact the cut kimchi and, thus, the cut kimchi is not preferably scattered.

In the cutting (S60), the kimchi is preferably cut into 2 to 10 cm which is an optimized size to eat. More preferably, the kimchi may be cut into 3 to 5 cm when different personal preferences are considered.

In this regard, since a cut length of the molded kimchi may be adjusted according to a movement rate and cutting frequencies per minute of the cutting blade 310, the molded kimchi may be cut into a variety of sizes.

The packing (S70) is a step of packing one piece or more of the cut kimchi into a unit.

More particularly, the packing (S70) is a step of packing desired pieces of the kimchi which is moved by the second conveyor 330 after being cut, as illustrated in FIG. 4.

In an embodiment, one piece of the Chinese cabbage kimchi is cut into a size of 70×50×50 mm and the weight of the piece is approximately 150 g which is proper for a family of four to eat at a meal. Therefore, in the packing step (S70), the kimchi may be packed by one piece.

According to a method of directly insert seasoning into a salted whole Chinese cabbage by persons, 30 to 40 kg of whole kimchi may be manufactured per hour. On the other hand, according to the method of the present, cut whole kimchi may be manufactured in the amount of 250 to 300 kg per hour.

Based on final products, the method according the present invention has 8 times higher productivity, when compared with the conventional method. In addition, the present invention may provide kimchi having delicately cut appearance and a uniformly salted state to consumers.

The method of manufacturing kimchi which is cut is not limited to the examples described above. Hereinafter, preferred examples will be provided for better understanding of the present invention. It will be apparent to those skilled in the art that these examples are only provided to illustrate the present invention and various modifications and alterations are possible within the scope and technical range of the present invention. Such modifications and alterations fall within the scope of claims comprised herein.
S10: SALTING
S20: WASHING
S30: MIXINGS
S40: ARRANGING
S50: MOLDING
S60: CUTTING
S70: PACKING
100: SORTER
110: BASE
120: VIBRATOR
130: VIBRATION TRANSMISSION MEMBER
140: GUIDES
200: MOLD
210: FIRST CONVEYOR
220: PRESSURE ROLLER
230: SUPPORT BOARD
300: CUTTER
310: CUTTING BLADE
320: OPERATION PART
330: SECOND CONVEYOR

What is claimed is:

1. A method of manufacturing cut whole kimchi, the method comprising:
separating each of Chinese cabbage leaves and then salting;
washing the salted Chinese cabbage leaves with water:
mixing the washed Chinese cabbage leaves and seasoning to manufacture kimchi;
arranging the mixed kimchi in a long axial direction using a sorter to laminate;
cutting the arranged kimchi into a constant size using a cutter; and
packing the cut kimchi.

2. The method according to claim 1, further comprising molding by pressing the arranged kimchi in a mold before the cutting.

3. The method according to claim 1, wherein a size of kimchi cut by the cutting is 2 to 10 cm.

4. The method according to claim 1, wherein the sorter comprises:
a base on which the kimchi is deposited;
a vibrator to move the kimchi in one direction using vibration by providing the vibration to the base;
a vibration transmission member to transmit the vibration of the vibrator to the base, one terminal of the vibration transmission member being installed at the base and another terminal of the vibration transmission member being installed at the vibrator; and
guides, each of the guides being installed at both sides of an upper portion of the base and an interval of the guides being narrowed in a direction in which the kimchi moves on the base by the vibration of the vibrator.

5. The method according to claim 4, wherein irregularities or embossments are formed on or a mash net is adhered to the upper surface of the base.

6. The method according to claim 2, wherein the mold comprising:
a first conveyor to move the kimchi while supporting a lower portion of the kimchi;
a pressure roller disposed on an upper portion of the first conveyor to downwardly press the kimchi moved by the first conveyor; and
a support board to support both sides of the kimchi pressed by the pressure roller.

7. The method according to claim 1, wherein the cutter comprising:
a cutting blade to cut the kimchi;
an operation part to drive the cutting blade; and
a second conveyor to move the kimchi cut by the cutting blade.

8. The method according to claim 7, wherein the cutting blade is formed in a crescent shape to install one terminal of the cutting blade at the operation part and the operation part upwardly and downwardly moves the cutting blade while rotating the cutting blade.

9. The method according to claim 7, wherein the cutting blade is formed in an ax shape or a circular shape.
